(19) United States
(12) Patent Application Publication
(10) Pub. No.: US 2026/0065105 A1
(43) Pub. Date: Mar. 5, 2026

(54) TIME-MULTIPLEXED ACOUSTIC ISING MACHINE

(71) Applicant: SPINWAVE COMPUTING AB, Sollentuna (SE)

(72) Inventors: Artem LITVINENKO, Göteborg (SE); Roman KHYMYN, Lindome (SE); Johan AKERMAN, Sollentuna (SE)

(73) Assignee: SPINWAVE COMPUTING AB, Sollentuna (SE)

(21) Appl. No.: 19/104,151

(22) PCT Filed: Aug. 19, 2023
(86) PCT No.: PCT/SE2023/050842

§ 371 Date: Feb. 14, 2025

(30) Foreign Application Priority Data
Aug. 19, 2022 (SE) 2250979-8
May 11, 2023 (SE) 2330212-8

(51) Int. Cl. G06N 7/01

(52) U.S. Cl. CPC G06N 7/01

(57) ABSTRACT

A time-multiplexed Ising computational machine, AWIM, comprising: a ring circuit comprising: an acoustic delay line for propagating a plurality artificial Ising spinwave pulses, an electronic phase-sensitive amplifier electrically connected to the acoustic delay line configured to cause phase degeneracy of the plurality of propagating artificial Ising spinwave pulses. The AWIM also comprises a measuring unit, interaction unit and an annealing and computing unit.

### FIELD OF THE INVENTION

The disclosed invention generally relates to non-von-Neuman computing architectures and more particularly to a combinatorial acoustic Ising-model solver using the physical annealing method.

### BACKGROUND OF THE INVENTION

The Ising Model (S. Kirkpatrick, C. D. Gelatt, M. P. Vecchi, Science 220, 671, 1983) is an efficient computational tool that can be used to solve a variety of difficult computational problems time- and hardware-efficiently by using its physical implementation—Ising machine. Ising model manifests that if there is a magnetic structure that is made of an array of magnetic domains and each domain is either up or down cᵢ, cⱼ:+1 or −1 magnetic spin and they are coupled to each other through a magnetic field with a coefficient Jᵢⱼ, one can calculate the energy of the whole system by simple summation of the product of each spin state in the pairs and their coupling:

$$E = - {\sum }_{i , j} {J}_{ij} {c}_{i} {c}_{j} \qquad ( 1 )$$

The Ising problem is to find for a given magnetic structure with particular coupling between elements, a unique configuration of spins (up or down) so that the whole magnetic structure has the lowest energy state. The Ising problems belong to the category of so-called NP-hard computational problems (F. Barahona, Journal of Physics A: Mathematical and General 15, 3241, 1982). The term hard means that this problem is representative of the whole class of NP and can be mapped to an Ising machine.

An Ising machine can be implemented with a physical system that is made of an array of elements where each element has two well-defined and stable states that can be either +1 or −1 to represent an Ising spin and where each element can be connected to any other with a variable coefficient. By setting different coefficients one can program this machine to solve a particular Ising problem. An Ising machine when turned on tends to go into the lowest energy state by flipping the states of individual spins. The final configuration of the spins coincides with the ground state of the Ising problem and represents its solution.

To date, Ising machines have been implemented with many physical paradigms, including quantum annealing (Johnson, M., Amin, M., Gildert, S. et al. Quantum annealing with manufactured spins. Nature 473, 194-198, 2011 & Davide Venturelli, Salvatore Mandrà, Sergey Knysh, Bryan O'Gorman, Rupak Biswas, and Vadim Smelyanskiy. Phys. Rev. X 5, 031040—Published 18 Sep. 2015), optical parametric oscillators (McMahon, Peter L., Alireza Marandi, Yoshitaka Haribara, Ryan Hamerly, Carsten Langrock, Shuhei Tamate, Takahiro Inagaki et al. A fully programmable 100-spin coherent Ising machine with all-to-all connections. Science 354, no. 6312, 2016:614-617 & Inagaki, Takahiro, Yoshitaka Haribara, Koji Igarashi, Tomohiro Sonobe, Shuhei Tamate, Toshimori Honjo, Alireza Marandi et al. A coherent Ising machine for 2000-node optimization problems. Science 354, no. 6312, 2016:603-606 & Honjo, Toshimori, Tomohiro Sonobe, Kensuke Inaba, Takahiro Inagaki, Takuya Ikuta, Yasuhiro Yamada, Takushi Kazama et al. 100,000-spin coherent Ising machine. Science advances 7, no. 40, 2021), phase transition nano-oscillators (Dutta, S., A. Khanna, J. Gomez, K. Ni, Z. Toroczkai, and S. Datt. Experimental demonstration of phase transition nano-oscillator based Ising machine. In 2019 IEEE International Electron Devices Meeting IEDM, pp. 37-8. IEEE, 2019), stochastic nanomagnets (Sutton, Brian, Kerem Yunus Camsari, Behtash Behin-Aein, and Supriyo Datt. Intrinsic optimization using stochastic nanomagnets Scientific reports 7, no. 1, 2017:1-9), electronic CMOS SRAM (M. Yamaoka, C. Yoshimura, M. Hayashi, T. Okuyama, H. Aoki and H. Mizun, A 20k-Spin Ising Chip to Solve Combinatorial Optimization Problems With CMOS Annealing in IEEE Journal of Solid-State Circuits, vol. 51, no. 1, pp. 303-309, January 2016, doi: 10.1109/JSSC.2015.2498601), electronic LC oscillators (Tianshi Wang, Leon Wu, and Jaijeet Roychowdhury. 2019. New Computational Results and Hardware Prototypes for Oscillator-based Ising Machines. In Proceedings of the 56th Annual Design Automation Conference 2019. Association for Computing Machinery, New York, NY, USA, Article 239, 1-2. & Wang, Tianshi and Jaijeet S. Roychowdhury. “OIM: Oscillator-based Ising Machines for Solving Combinatorial Optimisation Problems” UCNC, 2019), propagating spinwave (Litvinenko, A., Khymyn, R., González, V. H., Awad, A. A., Tyberkevych, V., Slavin, A., and Åkerman, J. (2022). A spinwave Ising machine. arXiv preprint arXiv:2209.04291) and spin-Hall nano-oscillators (Albertsson, Dagur Ingi, Mohammad Zahedinejad, Afshin Houshang, Roman Khymyn, Johan Åkerman, and Ana Rus “. Ultrafast Ising Machines using spin torque nano-oscillators. Applied Physics Letters 118, no. 11, 2021 &. McGoldrick, Brooke C., Jonathan Z. Sun, and Luqiao Li. Ising machine based on electrically coupled spin Hall nano-oscillators. Physical Review Applied 17, no. 1, 2022). All the concepts are characterized by different speeds, power consumption, number of supported spins, physical dimension, etc. but can still be divided into two distinct groups-spatially distributed oscillator arrays and time-multiplexed soliton systems as shown in FIGS. 1A and 1B.

The most important parameters for Ising Machines are the time to solution and the number of supported spins, and these parameters are strongly interconnected. In FIG. 1C we present time to solution as a function of annealing time and problem size N. For Ising Machines based on physical arrays of oscillators the main problem is interconnectivity because as the number of oscillators N grows the number of intersections between coupling lines increases dramatically as —O(N²). This problem is solved by grouping the elements with a sparse connection into a so-called chimera graph. However, it trades off the computational time-to-solution which in the case of the chimera graph connection scheme increases as —O(N²) (FIG. 1C). It is the same growth rate as the computation speed of classical computers based on a von-Neuman architecture which means that there is no principal computational advantage in using Ising Machines built with spatially distributed oscillators.

For Coherent Ising Machines based on propagating light pulses and Spinwave Ising Machines based on propagating spinwave RF pulses the interconnectivity for a problem of all-to-all or densely connected spins is easily solved with the time-multiplexing method. Computational problems with all-to-all connected spins are characterized by the computational time that grows as —O(\sqrt{N}) when solved on physical Ising Machines. Therefore, the time multiplexing method makes computational time to solution for Ising problems with a large (>50) number of spins reasonable. The first time-multiplexing Ising Machine was implemented with optical parametric oscillators (OPOs) that are in the form of propagating light pulses in optical waveguides. The interconnectivity is implemented electrically (FIG. 1B) by consecutive measurements of each propagating light pulses-OPOs and then adding to the additional small (r<<1) contributions according to the coefficients in Ising problem:

$${f}_{i} = r {\sum }_{j} {J}_{ij} {c}_{j} \qquad ( 2 )$$

$${J}_{ij} = \{ \begin{matrix}{J}_{11} & … & {J}_{1 j} \\ ⋮ & ⋱ & ⋮ \\ {J}_{i 1} & … & {J}_{ij}\end{matrix} \} \qquad ( 3 )$$

For the moment, time-multiplexed IMs seem to be the most promising Ising Machine configuration for combinatorial problems with large (>50 number of elements) due to —O(\sqrt{N}) computational speed. Even SHNO-based Ising Machines that are projected to provide unprecedented computational speed starting from tens of nanoseconds cannot compete with Coherent Ising Machines for a graph size above 50 as they belong to —O(N²) class of IM. The number of supported elements in Ising problems solved by optical CIMs was progressively growing from 100 (McMahon, Peter L et al. 2016) spins through 2000 (Inagaki, Takahiro et al. 2016) and recently a CIM supporting 100000 spins was reported (Honjo, Toshimori et al. 2021). However, despite clear progress in the number of supported spins, current CIMs are still not in the market as they have a considerable disadvantage of size, large power consumption, and, most importantly, costly optical infrastructure requiring optical tables, precise positioners, etc. This motivated the present inventors' work on spinwave Ising machines (SWIM) (Litvinenko, A. et al. 2022) which allows sufficient reduction in power consumption due to multiphysical design and miniaturization due to low propagational speed of spinwaves. However, SWIM suffers from spinwave dispersion that broadens propagating spinwave RF pulses and limits the spin capacity.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing an acoustic Ising computational machine, AWIM, comprising: a ring circuit comprising: an acoustic line for propagating a plurality artificial Ising spinwave ultrasonic or RF pulses, an electronic phase-sensitive amplifier electrically connected to the acoustic delay line configured to cause phase degeneracy of the plurality of propagating artificial Ising spinwave pulses. A measuring unit in connection with the ring circuit, the measuring unit configured to measure the phase of each of the plurality of artificial Ising spinwave pulses. An interaction unit for implementing the magnitude and phase of the interactions corresponding to the artificial spinwave pulses. The AWIM comprising an annealing and computing unit configured to perform annealing of the plurality of artificial Ising spinwave pulses and perform statistical analysis on the plurality of steady-state solutions of the Ising machine.

This disclosure relates to a novel architecture of time-multiplexed Acoustic Wave Ising Machines (AWIM) for solving combinatorial optimization problems. The key element of Acoustic Wave IM (AWIM) is an acoustic delay line that is used as a waveguide where acoustic RF or ultrasonic pulses propagate and are stored. The advantage of acoustic devices is the exceptionally slow group velocity of propagating acoustics that is several orders lower than the speed of light. It allows miniaturizing of the CIM waveguide size down to the mm scale while keeping a high number of supported spins. Another advantage of the proposed invention in contrast to spinwave IMs is that acoustic waves have intrinsically linear dispersion that allows to excite very short RF or ultrasonic pulses not limited by nonlinear dispersion. AWIM also allows performing the compensation of propagation losses via low-power and power-efficient RF phase-sensitive and linear amplifiers. Acoustic delay line can be of several types including magnetoacoustic wave-based, Surface Acoustic Wave (SAW), Bulk Acoustic Wave (BAW) operating at frequencies from MHz to GHz and having delay times from ns to ms range. The transformation between acoustic RF or ultrasonic pulses to electric RF or LF pulses and back can implemented with different types of transducers-interdigital SAW and thin film BAW. The rapid measurement of RF circulating pulses can be done electrically via ready-from-the-shelf logarithmic phase and amplitude detectors or using homodyne IQ-demodulator and CORDIC algorithm implemented in microcontroller or FPGA that allows independent deduction of the phase and the amplitude of the RF or LF pulses within pulse circulation time.

An Ising model computational method is also provided.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1A. is a spatially distributed oscillator array Ising Machine.

FIG. 1B is a time-multiplexed Ising Machine.

FIG. 1C is a graph showing time to solution as a function of annealing time and problem size N, showing a comparison between existing solutions to the present disclosure, which is shown as the dashed line labelled Acoustic Ising Machine GU.

FIG. 2 is a block diagram of an Acoustic Ising Machine according to an aspect. The block diagram shows interconnections and interactions between elements of the Acoustic Ising Machine.

FIG. 3A is a schematic diagram of a magnetoelastic implementation of an Acoustic Delay line.

FIG. 3B is a schematic diagram of a surface acoustic wave implementation of an Acoustic Delay line.

FIG. 3C is a schematic diagram of a bulk acoustic wave implementation of an Acoustic Delay line.

FIG. 4 shows the S₂₁-parameter of an acoustic delay line.

FIG. 5 shows the amplification of the phase-sensitive amplification block as a function of phase difference between circulating RF pulses and a reference signal.

FIG. 6 shows time traces of envelop of amplitude of circulating RF pulses, their instantaneous phase and a control signal loop amplification and calculated Ising Energy.

FIG. 7 shows graphs A, B and C for 16-spin MAX-CUT test problem and the corresponding probabilities of possible solutions.

FIG. 8A shows graphs B2 for 50-spin MAX-CUT test problem and the corresponding probabilities of possible solutions.

FIG. 8B shows graphs B2 for 50-spin MAX-CUT test problem and the corresponding probabilities of possible solutions.

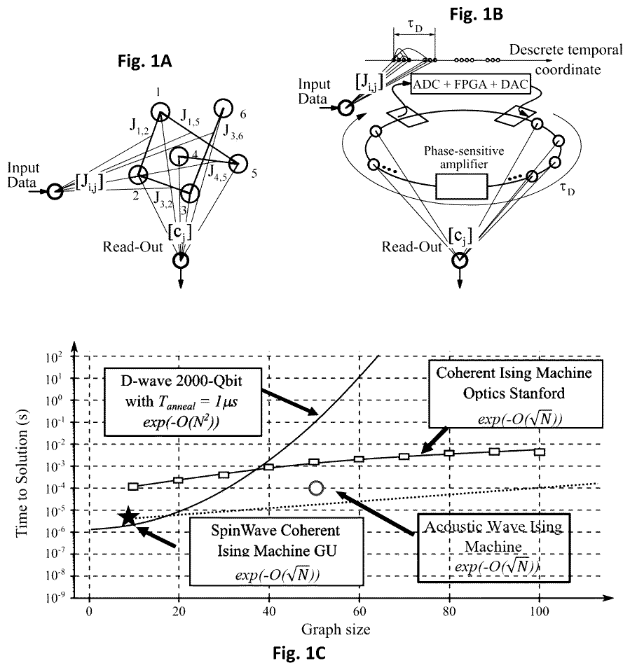

### DETAILED DESCRIPTION

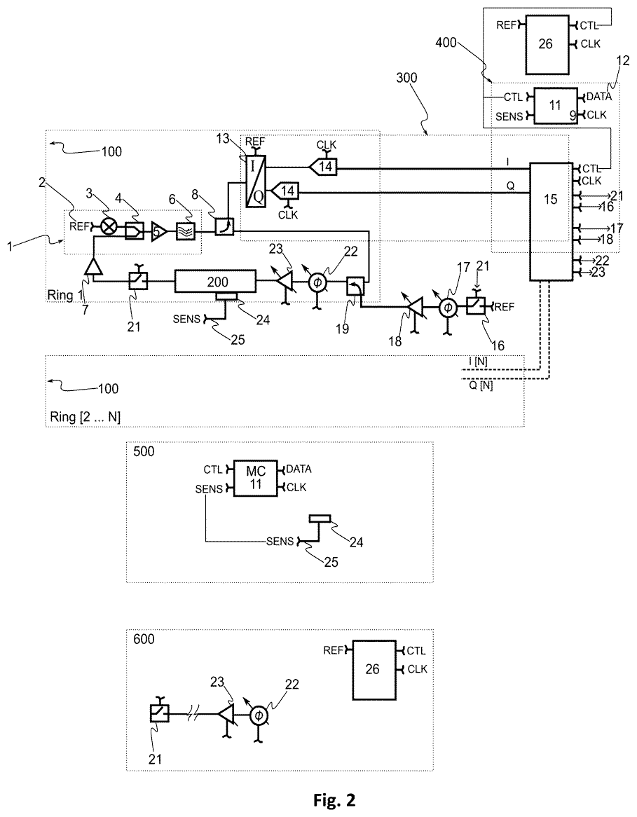

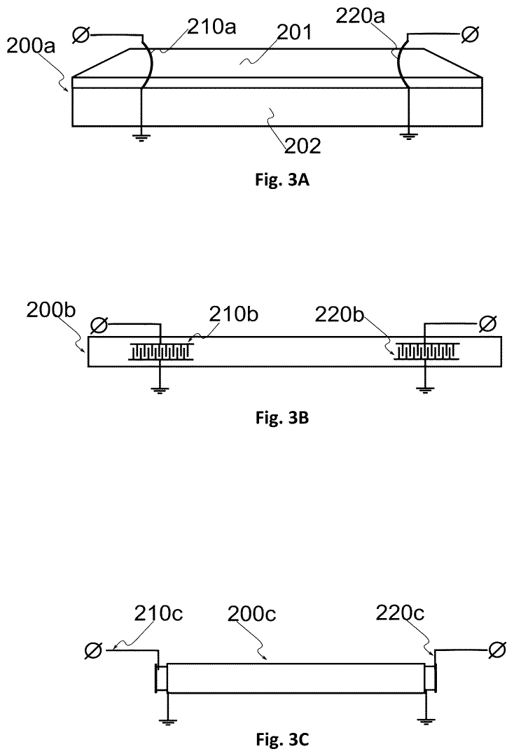

FIGS. 2 and 3A-C show a time multiplexed acoustic wave Ising machine (AWIM). The AWIM comprises a ring circuit 100, the ring circuit 100 comprises an acoustic delay line 200 that supports up to N Ising spins in the form of propagating acoustic RF pulses. The acoustic delay line 200 can be magnetoelastic 200a, SAW 200b, or BAW 200c, based operating at different frequencies from MHz to GHz range and having delay times from ns to ms range. The AWIM comprises an electronic part 100, 300 and the physical acoustic delay line 200. The electronic part is for linear and parametric amplification of RF pulses, RF pulse interconnection, and RF pulse measurement. The RF pulses propagate as artificial Ising spin pulses in the electronic part 100, 300, 400, 500 and may be measured, amplified, interconnected via the electronic part 100, 300, 400, 500. The RF pulses propagate as acoustic RF or ultrasonic pulses in the acoustic delay line 200.

In FIG. 3A, the acoustic delay line 200 is a magnetoelastic substrate 200a. The magnetoelastic substrate 200A may comprise a thin film 201 covering a thicker bulk substrate 202. For example, an Yttrium Iron Garnet, YIG thin film 201 covering a Gadolinium Gallium Garnet, GGG bulk substrate 202. As shown in FIG. 3A, the acoustic delay line 200 is provided with input 210a and output 220a electromagnetic to spinwave transducers. The electromagnetic to spinwave transducers 210a, 220a may be a thin wire electromagnetic to spinwave transducers 210a, 220a as shown in FIG. 3A. The electromagnetic to spinwave input transducer 210a convert input electric pulses to spinwaves in the thin film 201. The spinwaves excite bulk acoustic waves in the bulk substrate 202. The bulk acoustic waves generate spinwaves in the thin film 201 near the output transducer 220a. The spinwaves in the thin film 201 induce electromagnetic waves at the output transducer 220a as electric signals which then propagate from the transducer 220a in the ring circuit 100.

FIG. 3B shows a SAW substrate 200b. The SAW substrate 200b may be a suitable SAW propagating substrate as known within the field of SAW devices. The acoustic delay line 200b in FIG. 2C is provided with input 210b and output 220b SAW transducers. As is shown in FIG. 3B, the SAW transducers 210b, 220b may be a thin film interdigitated grating as is known within the field of SAW transducers. The input SAW transducer 210b converts the input electric pulses to SAWs in the substrate 200b. The SAWs induce electromagnetic waves at the output SAW transducer 220b, which then propagate as electric signals from the transducer 220b in the ring circuit 100.

FIG. 3C shows a bulk acoustic wave propagating acoustic delay line 200c. The bulk acoustic wave propagating acoustic delay line 200c comprises a bulk acoustic wave propagating substrate 200c. The bulk acoustic wave propagating substrate 200c may be a suitable BAW propagating substrate as is known within the field. The BAW acoustic delay line 200c is provided with input 210c and output 220c electric to BAW transducers. As above, the input transducer 210c converts the electric pulses to BAWs in the substrate 200c. The output transducer 220c converts the bulk acoustic waves to electric signals, which then propagate from the transducer 220c in the ring circuit 100. The BAW transducers 210c, 220c may be for example ZnO transducers. Both RF and ultrasonic BAWs are propagated by the acoustic delay line 200c.

The AWIM comprises a phase-sensitive amplification block 1. The operating frequency ƒ₀ of AIM is set by the phase-sensitive amplification block 1 via a reference signal 2 with frequency ƒ_{ref}=ƒ₀. As shown in FIG. 2, the acoustic delay line 200, and the phase-sensitive amplification block 1 are comprised within a ring circuit 100 of the acoustic wave Ising machine. The losses in acoustic delay line 200 are compensated by the phase-sensitive block 1 and a linear amplifier 7. The phase of each circulating RF pulse cⱼ is measured by deflecting 1-10% of power after a filter 6 with a directional coupler 8, and measuring the phase with an IQ-demodulator 13, 2-channel ADC 14, and a CORDIC algorithm implemented in an FPGA 15. The FPGA 15 also performs the computation of the Ising matrix and sets the coupling between each Ising spin by controlling a phase shifter 17 and variable amplifier 18 which change the phase and the amplitude of additional coupling RF pulses that are formed by an RF switch 16. Coupling RF pulses after a variable amplifier 18 are added to the circulating RF pulses in the ring circuit 100 via power coupler 19.

As shown in FIG. 2, the AWIM comprising an FPGA 15 comprises a microcontroller 11. The microcontroller 11 controls the FPGA 15, clock frequencies 9, performs an annealing procedure, and optionally communicates with external systems 12 via a data line. The microcontroller 11 and the FPGA therefore form an annealing and computing unit 400. The annealing and computing unit 400, comprising the microcontroller 11 and the FPGA 15 are configured to the perform annealing by restarting the circulation of the artificial Ising spin pulses.

As shown in FIG. 2, the FPGA 15 receives the phase of the artificial Ising spin pulses from the IQ-demodulator 13 as both I and Q components into separate input lines. The FPGA 15 controls the ring circuit 100 RF switch 21. As described above, the FPGA 15 controls the RF switch 16 providing the additional RF pulses. The FPGA 15 controls the digital phase shifter 17 and digital attenuator 18. The FPGA 15 also controls a ring phase shifter 22, and a ring attenuator 23. The ring phase shifter 22 stabilises oscillations within the ring circuit 100. The ring phase shifter 22 is advantageous as the delay time of the oscillations may change due to, for example, thermal expansion. The phase shifter 22 maintains the same accumulation of phase in the ring 100 to satisfy Barkhausen criteria for stable oscillations. The ring attenuator 23 changes the amplification in the ring 100 which is used to perform system annealing using the minimal gain principle.

RF switch 16, digital phase shifter 17, and digital attenuator 18, and RF coupler combine to form an interaction unit 350. The interaction unit 350 receives input from the FPGA 15 and is configured via the components 16, 17, 18, 19 to implement the magnitudes and phases of the interactions relating to each of the plurality of artificial Ising spin pulses.

The IQ-demodulator 13, ADC 14 and FPGA 15 form a measurement unit 300 for measuring the phase of the artificial spins propagating in the ring circuit 100. The measurement unit 300 measures the phase of each of the plurality of artificial spins propagating in the ring circuit 100. Additionally, the directional coupler 8 may be considered to be part of the measurement unit 300 as the measurement unit 300 receives the artificial spin pulses via the directional coupler 8. The measuring unit 300 is configured to measure instantaneously the phase of each of the plurality of artificial Ising spins propagating in the circuit 100. The measuring unit 300 is configured to suspend measurement after one set of measurement is completed. The measuring unit 300 restarts measurements measurement thereafter.

The AWIM may also comprise a temperature control and stabilisation unit 500. The temperature control and stabilisation unit 500 comprises a heating element 24 in physical contact with the acoustic delay line 200, and a temperature sensor 25. The temperature sensor 25 measures the temperature of the acoustic delay line 200 and transmits the temperature, or a value corresponding to the temperature, to the microcontroller 11. The microcontroller 11 can then control the heating element 24 such that the temperature of the acoustic delay line 200 is maintained within ideal operating parameters.

The AWIM may also comprise a spin stabilisation unit 600. The spin stabilisation unit 600 is configured to stabilise the reference frequency, control Barkhausen criteon of stability for each of the plurality of artificial spin pulses circulating in the ring circuit 100. The spin stabilisation unit may also adjust amplification and phase accumulation in the ring circuit 100. The spin stabilisation unit 600 comprises a phase-locked loop, PLL, frequency synthesis block 26 comprising a PLL synthesiser, a ring attenuator 23, a ring phase shifter 22, and an RF switch 21. Each of the ring attenuator 23, the ring phase shifter 22, and the RF switch 21 are connected in the ring circuit 100 and receive the output artificial Ising spin pulses from the output transducer 220.

As would be apparent from the disclosure, various electronic components of the AWIM are comprised within the measurement unit 300, the interaction unit 350, the annealing and computing unit 400, as well as the temperature stabilisation unit 500 and the spin stabilisation unit 600. The parallel use of the various components is advantageous as it enables a smaller, lower power Ising machine compared to existing devices. The terms measurement unit 300, interaction unit 350 and annealing and computing unit 400 are used to define the functional separation of various aspects of the AWIM, however, the functional separation need not correspond to the electrical or physical separation.

The number N of supported spins is proportional to the total delay time τ_{delay} in a acoustic delay line and inversely proportional to the minimum possible acoustic RF or ultrasonic pulse width τₚ:

$$N = \frac{{τ}_{delay}}{{τ}_{p}} \qquad ( 4 )$$

The minimum possible acoustic RF or ultrasonic pulse duration is limited by the 3-dB bandwidth BW_{sw}:

$${τ}_{p} \geq \frac{1}{{BW}_{sw}} \qquad ( 5 )$$

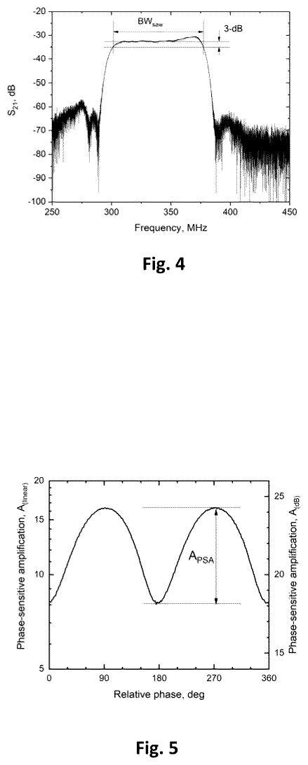

FIG. 4 shows S₂₁-parameter of an acoustic delay line in the form of S₂₁-parameter. The bandwidth of the acoustic generation spectrum is 80 MHz measured at −3 dB level. The mean delay time τ_{delay} is 12000 ns. The limit of minimal pulse duration derived from bandwidth is 12.5 ns. However, it is important to have at least 10 oscillations within the RF pulse which is 30 ns and that results in the limit of 400 of maximum supported Ising spins in the AWIM.

Phase sensitivity is achieved by doubling the reference signal frequency via a frequency doubler 3 and combining it with an RF signal via a coupler 4 converted from acoustic RF pulses form the acoustic substrate delay line 200. The amplitude of the total signal after power divider/coupler 4 is set at a level that is close to the saturation point of an RF amplifier 5. The amplitudes of the signals at two inputs of a power divider/coupler 4 which have a relative phase close to 0° or 180° are added and the total signal amplification is affected by the saturation of the amplifier 5 more than if signals have a phase difference is close to 90° or 360°. The signal after an amplifier 5 is filtered by a highpass filter 6 with a cut of frequency ƒ₀ to remove 2ƒ₀ signal after phase-sensitive amplification.

FIG. 5 shows the amplification of the phase-sensitive amplification block 1 as a function of a phase difference between the circulating RF pulses and the reference signal 2. The difference in amplification is denoted as A_{PSA}, which equals 6 dB and represents the phase sensitivity of the block 1. The value of phase sensitivity can be adjusted by changing the amplitude of the reference signal at the input of the frequency multiplier.

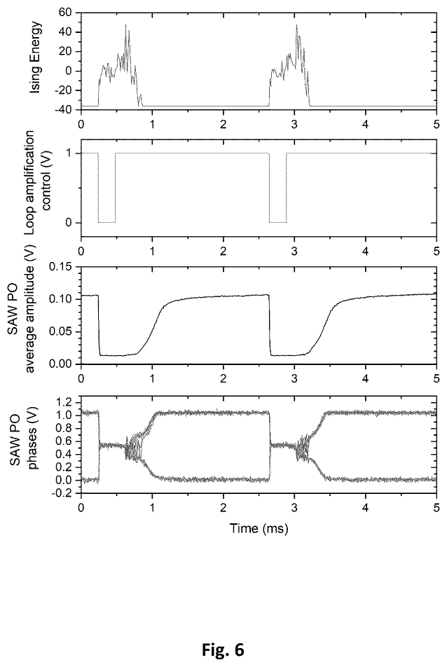

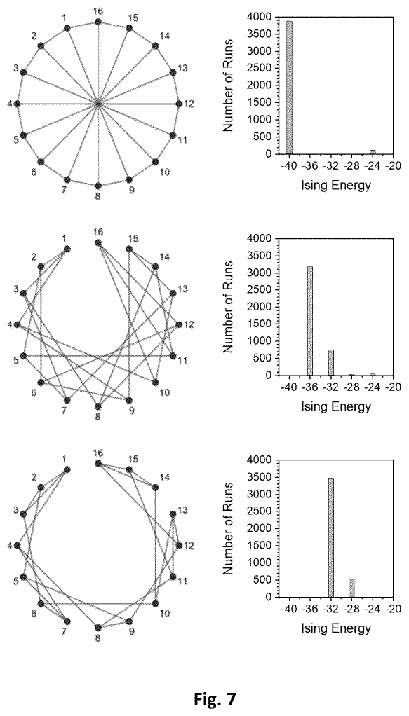

FIG. 6 shows time evolution of phases of SAW RF pulses, their average amplitude for each cycle, time traces of loop amplification control and, finally, time trace of the Ising Energy of the SAW-based IM.

FIG. 2 shows an AWIM comprising a plurality of ring circuits 100, ring 1 at the top, and ring 2 to ring N beneath as the dotted box. Each ring circuit 100 comprises a respective acoustic delay line 200, and a phase sensitive amplifier 1. Each ring circuit 100 is connected to the FPGA 15, the FPGA thus forming at least the annealing and computing unit. Due to the reduced physical and power footprint of the present ring circuit 100, multiple ring circuits 100 are practically feasible in a single AWIM. Each ring circuit may comprise a respective electric linear amplifier 7. The plurality of ring circuits 100 enables an increased number of spins to be performed by the AWIM.

### EXAMPLES

16-Spin and 50-Spin MAX-CUT Problems with AWIM

The following illustrative example demonstrates the physical mechanisms and routes for obtaining a solution to simple 16-spin and 50-spin MAX-CUT problem and is representative of embodiments of the schematic design, the physical parameters, and methods described herein are not meant to be limiting.

FIG. 6 shows three 16-spin MAX-CUT problems with different connection schemes which are described by the following Ising matrix:

$${J}_{ij} = \{ \begin{matrix}0 & - 1 & 0 & 0 & 0 & 0 & 0 & 0 & - 1 & 0 & 0 & 0 & 0 & 0 & 0 & - 1 \\ - 1 & 0 & - 1 & 0 & 0 & 0 & 0 & 0 & 0 & - 1 & 0 & 0 & 0 & 0 & 0 & 0 \\ 0 & - 1 & 0 & - 1 & 0 & 0 & 0 & 0 & 0 & 0 & - 1 & 0 & 0 & 0 & 0 & 0 \\ 0 & 0 & - 1 & 0 & - 1 & 0 & 0 & 0 & 0 & 0 & 0 & - 1 & 0 & 0 & 0 & 0 \\ 0 & 0 & 0 & - 1 & 0 & - 1 & 0 & 0 & 0 & 0 & 0 & 0 & - 1 & 0 & 0 & 0 \\ 0 & 0 & 0 & 0 & - 1 & 0 & - 1 & 0 & 0 & 0 & 0 & 0 & 0 & - 1 & 0 & 0 \\ 0 & 0 & 0 & 0 & 0 & - 1 & 0 & - 1 & 0 & 0 & 0 & 0 & 0 & 0 & - 1 & 0 \\ 0 & 0 & 0 & 0 & 0 & 0 & - 1 & 0 & - 1 & 0 & 0 & 0 & 0 & 0 & 0 & - 1 \\ - 1 & 0 & 0 & 0 & 0 & 0 & 0 & - 1 & 0 & - 1 & 0 & 0 & 0 & 0 & 0 & 0 \\ 0 & - 1 & 0 & 0 & 0 & 0 & 0 & 0 & - 1 & 0 & - 1 & 0 & 0 & 0 & 0 & 0 \\ 0 & 0 & - 1 & 0 & 0 & 0 & 0 & 0 & 0 & - 1 & 0 & - 1 & 0 & 0 & 0 & 0 \\ 0 & 0 & 0 & - 1 & 0 & 0 & 0 & 0 & 0 & 0 & - 1 & 0 & - 1 & 0 & 0 & 0 \\ 0 & 0 & 0 & 0 & - 1 & 0 & 0 & 0 & 0 & 0 & 0 & - 1 & 0 & - 1 & 0 & 0 \\ 0 & 0 & 0 & 0 & 0 & - 1 & 0 & 0 & 0 & 0 & 0 & 0 & - 1 & 0 & - 1 & 0 \\ 0 & 0 & 0 & 0 & 0 & 0 & - 1 & 0 & 0 & 0 & 0 & 0 & 0 & - 1 & 0 & - 1 \\ - 1 & 0 & 0 & 0 & 0 & 0 & 0 & - 1 & 0 & 0 & 0 & 0 & 0 & 0 & - 1 & 0\end{matrix} \} \qquad ( 7 a )$$

$${J}_{ij} = \{ \begin{matrix}0 & - 1 & - 1 & - 1 & 0 & 0 & 0 & 0 & 0 & 0 & 0 & 0 & 0 & 0 & 0 & 0 \\ - 1 & 0 & - 1 & 0 & - 1 & 0 & 0 & 0 & 0 & 0 & 0 & 0 & 0 & 0 & 0 & 0 \\ - 1 & - 1 & 0 & 0 & 0 & - 1 & 0 & 0 & 0 & 0 & 0 & 0 & 0 & 0 & 0 & 0 \\ - 1 & 0 & 0 & 0 & 0 & 0 & - 1 & - 1 & 0 & 0 & 0 & 0 & 0 & 0 & 0 & 0 \\ 0 & - 1 & 0 & 0 & 0 & 0 & - 1 & 0 & - 1 & 0 & 0 & 0 & 0 & 0 & 0 & 0 \\ 0 & 0 & - 1 & 0 & 0 & 0 & - 1 & 0 & 0 & - 1 & 0 & 0 & 0 & 0 & 0 & 0 \\ 0 & 0 & 0 & - 1 & - 1 & - 1 & 0 & 0 & 0 & 0 & 0 & 0 & 0 & 0 & 0 & 0 \\ 0 & 0 & 0 & - 1 & 0 & 0 & 0 & 0 & 0 & 0 & - 1 & 0 & 0 & 0 & 0 & 0 \\ 0 & 0 & 0 & 0 & - 1 & 0 & 0 & 0 & 0 & 0 & 0 & - 1 & 0 & 0 & 0 & 0 \\ 0 & 0 & 0 & 0 & 0 & - 1 & 0 & 0 & 0 & 0 & 0 & 0 & - 1 & - 1 & 0 & 0 \\ 0 & 0 & 0 & 0 & 0 & 0 & 0 & - 1 & 0 & 0 & 0 & 0 & - 1 & 0 & - 1 & 0 \\ 0 & 0 & 0 & 0 & 0 & 0 & 0 & 0 & - 1 & 0 & 0 & 0 & - 1 & 0 & 0 & - 1 \\ 0 & 0 & 0 & 0 & 0 & 0 & 0 & 0 & 0 & - 1 & - 1 & - 1 & 0 & 0 & 0 & 0 \\ 0 & 0 & 0 & 0 & 0 & 0 & 0 & 0 & 0 & - 1 & 0 & 0 & 0 & 0 & - 1 & - 1 \\ 0 & 0 & 0 & 0 & 0 & 0 & 0 & 0 & 0 & 0 & - 1 & 0 & 0 & - 1 & 0 & - 1 \\ 0 & 0 & 0 & 0 & 0 & 0 & 0 & 0 & 0 & 0 & 0 & - 1 & 0 & - 1 & - 1 & 0\end{matrix} \} \qquad ( 7 b )$$

$${J}_{ij} = \{ \begin{matrix}0 & - 1 & - 1 & - 1 & 0 & 0 & 0 & 0 & 0 & 0 & 0 & 0 & 0 & 0 & 0 & 0 \\ - 1 & 0 & 0 & 0 & - 1 & - 1 & 0 & 0 & 0 & 0 & 0 & 0 & 0 & 0 & 0 & 0 \\ - 1 & 0 & 0 & 0 & 0 & 0 & - 1 & - 1 & 0 & 0 & 0 & 0 & 0 & 0 & 0 & 0 \\ - 1 & 0 & 0 & 0 & 0 & 0 & 0 & 0 & - 1 & - 1 & 0 & 0 & 0 & 0 & 0 & 0 \\ 0 & - 1 & 0 & 0 & 0 & 0 & - 1 & 0 & 0 & 0 & - 1 & 0 & 0 & 0 & 0 & 0 \\ 0 & - 1 & 0 & 0 & 0 & 0 & 0 & 0 & - 1 & 0 & 0 & - 1 & 0 & 0 & 0 & 0 \\ 0 & 0 & - 1 & 0 & - 1 & 0 & 0 & 0 & 0 & 0 & 0 & 0 & - 1 & 0 & 0 & 0 \\ 0 & 0 & - 1 & 0 & 0 & 0 & 0 & 0 & 0 & 0 & 0 & - 1 & 0 & - 1 & 0 & 0 \\ 0 & 0 & 0 & - 1 & 0 & - 1 & 0 & 0 & 0 & 0 & 0 & 0 & 0 & 0 & - 1 & 0 \\ 0 & 0 & 0 & - 1 & 0 & 0 & 0 & 0 & 0 & 0 & 0 & 0 & - 1 & 0 & 0 & - 1 \\ 0 & 0 & 0 & 0 & - 1 & 0 & 0 & 0 & 0 & 0 & 0 & 0 & 0 & - 1 & 0 & - 1 \\ 0 & 0 & 0 & 0 & 0 & - 1 & 0 & - 1 & 0 & 0 & 0 & 0 & 0 & 0 & 0 & - 1 \\ 0 & 0 & 0 & 0 & 0 & 0 & - 1 & 0 & 0 & - 1 & 0 & 0 & 0 & 0 & - 1 & 0 \\ 0 & 0 & 0 & 0 & 0 & 0 & 0 & - 1 & 0 & 0 & - 1 & 0 & 0 & 0 & - 1 & 0 \\ 0 & 0 & 0 & 0 & 0 & 0 & 0 & 0 & - 1 & 0 & 0 & 0 & - 1 & - 1 & 0 & 0 \\ 0 & 0 & 0 & 0 & 0 & 0 & 0 & 0 & 0 & - 1 & - 1 & - 1 & 0 & 0 & 0 & 0\end{matrix} \} \qquad ( 7 c )$$

The problem (7) is mapped into the AWIM using an FPGA Xilinx Spartan-6 XC6SLX9. The FPGA 15 controls the amplitude and phase of the coupling RF pulses via a variable amplifier 18 and a phase shifter 17 according to the following equation

$${f}_{i} = r {\sum }_{i} {J}_{ij} {c}_{j} \qquad ( 8 )$$

The measurement block 300 comprising components 13, 14, 15 reads the instantaneous phase at the centre of each RF pulse, rounds its value, and processes the data as an intermediate state of the Ising system.

FIG. 7 also shows the statistics obtained with a SAW-based IM operating at 350 MHz of central frequency and 12 μs of the total delay time.

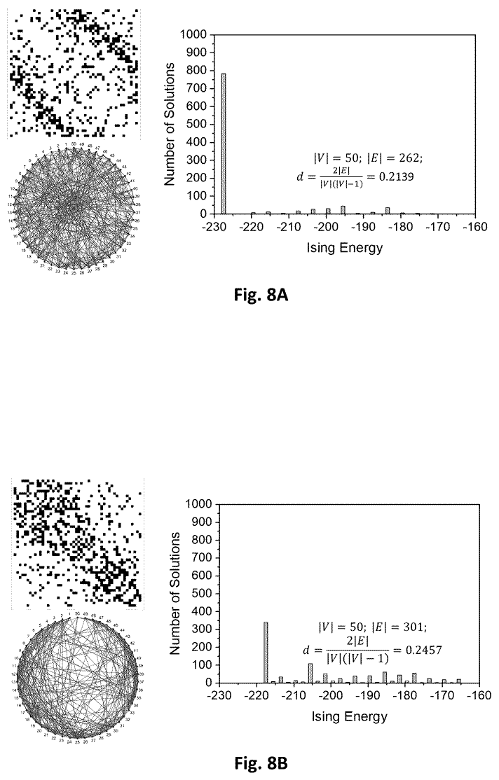

FIGS. 8A and 8B show two 50-spin MAX-CUT problems and representation of their coupling matrices in the form of greyscale maps.

FIGS. 8A and 8B also show the statistics obtained with a SAW-based IM operating at 350 MHz of central frequency and 12 us of the total delay time.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

### LIST OF REFERENCES USED IN THE FIGURES

| Reference Numbers | |
|---|---|
| (FIG. 2) | Element |
| 1 | Phase sensitive amplifier block |
| 2 | Reference signal |
| 3 | Frequency doubler |
| 4 | Power divider 1:1 |
| 5 | RF amplifier |
| 6 | Highpass filter |
| 7 | RF Amplifier |
| 8 | RF coupler 1:10 |
| 9 | Clock line |
| 10 | Control line |
| 11 | Microcontroller |
| 12 | Data line |
| 13 | I and Q demodulator |
| 14 | Analog to Digital Converter |
| 15 | Field-Programmable Gate Array |
| 17 | Digital phase shifter |
| 18 | Digital attenuator |
| 19 | RF coupler 1:10 |
| 200 | Acoustic delay line |
| 210a, | Input transducer |
| b, c | |
| 220a, | Output transducer |
| b, c | |
| 21 | RF switch |
| 22 | Loop phase shifter |
| 23 | Loop attenuator |
| 24 | Heating element |
| 25 | Temperature sensor |
| 26 | PLL frequency synthesis block |

1-19. (canceled)

20. A time-multiplexed Ising computational machine, AWIM, comprising:
a ring circuit, the ring circuit comprising:
an acoustic delay line (200) for propagating a plurality of artificial Ising spin pulses as parametric acoustic oscillators, and,
an electronic phase-sensitive amplifier in connection with the acoustic delay line, the phase-sensitive amplifier configured to cause phase degeneracy of the plurality of propagating acoustic pulses corresponding to a plurality of artificial spins in the Ising model, and to set an oscillation frequency corresponding to half a reference frequency, the reference frequency being provided by a reference signal;
the AWIM also comprising:
a measuring unit in connection with the ring circuit, the measuring unit configured to measure the phase of each of the plurality of artificial Ising spinwave pulses each time the plurality of pseudo spin pulses circularly propagates in the ring circuit;
an interaction unit in connection with the ring circuit, the interaction unit for implementing the magnitude and phase of the interactions corresponding to the artificial spinwave pulses; and,
an annealing and computing unit in connection with the ring circuit, the annealing and computing unit configured to perform annealing of the plurality of artificial Ising spinwave pulses and perform statistical analysis on the plurality of steady-state solutions of the Ising machine.

21. The AWIM according to claim 20, wherein the acoustic delay line is a magnetoelastic acoustic delay line, a surface acoustic wave, SAW, delay line, or a bulk acoustic wave, BAW, delay line.

22. The AWIM according to claim 20, wherein the acoustic delay line comprises an input transducer for converting electric signals from the ring circuit to propagating waves in the acoustic delay line.

23. The AWIM according to claim 20, wherein the acoustic delay line comprises an output transducer for converting propagating waves to electrical signals for propagation in the ring circuit.

24. The AWIM according to claim 20, wherein the AWIM comprises a temperature control and stabilization unit for controlling and stabilizing the temperature of the acoustic delay line, the temperature control and stabilisation unit comprising a heating element physically connected to the acoustic delay line and temperature sensor for measuring the temperature of the acoustic delay line.

25. The AWIM according to claim 20, wherein the AWIM comprises a spin stabilization unit, the spin stabilisation unit in electrical connection with the ring circuit and interaction unit, and configured to stabilize the reference frequency, control Barkhausen criterion of stability for the plurality of artificial Ising spin pulses circulating in the ring circuit, and adjust the amplification and phase accumulation in the ring circuit.

26. The AWIM according to claim 20, wherein the measuring unit is configured to instantaneously and repeatedly measure the phase of the plurality of artificial spin pulses propagating in the ring circuit.

27. The AWIM according to claim 21, wherein the acoustic delay line is a magnetoelastic acoustic delay line and wherein the acoustic delay line comprises thin wire input and output transducers.

28. The AWIM according to claim 27, wherein the acoustic delay line comprises a thin film substrate for propagating artificial spin waves, and a bulk substrate for propagating bulk acoustic waves.

29. The AWIM according to claim 21, wherein the acoustic delay line is a SAW acoustic delay line and wherein the acoustic delay line comprises interdigitated thin film input and output transducers for converting SAWs from and to electrical signals respectively.

30. The AWIM according to claim 21, wherein the acoustic delay line is a BAW acoustic delay line, and wherein the acoustic delay line comprises a BAW propagating substrate.

31. The AWIM according to claim 21, wherein the acoustic delay line comprises an acoustic wave propagating material in which RF or ultrasonic pulses propagate at a speed substantially less than the speed of light.

32. The AWIM according to claim 20, wherein the AWIM comprises a field programmable gate array, FPGA, configured to map an Ising problem onto propagating acoustic RF or ultrasonic pulses by connecting them, the connecting occurring via applying to each RF or ultrasonic pulse, an additional coupling RF or ultrasonic pulse with an amplitude and phase defined by a coupling matrix.

33. The AWIM according to claim 20, wherein the parametric acoustic oscillators are time-multiplexed in a single acoustic delay line.

34. The AWIM according to claim 20, wherein the AWIM comprises a plurality of ring circuits (100), each ring circuit (100) comprising a respective acoustic delay line and phase-sensitive amplifier.

35. An Ising model computation method comprising:
receiving in a ring circuit an electromagnetic RF pulse, the ring circuit comprising an acoustic delay line,
transforming the electromagnetic RF pulse to an acoustic artificial Ising spinwave pulse in the acoustic delay line via an input transducer;
transforming the acoustic artificial Ising spinwave pulse from the acoustic delay line to an artificial Ising spinwave RF pulse via an output transducer;
phase degenerating the artificial Ising spinwave RF pulse and setting an oscillation frequency corresponding to half a reference frequency provided by a reference signal via a phase-sensitive amplifier;
receiving the artificial spinwave Ising RF pulse at an interaction unit connected to the ring circuit and, implementing the magnitude and phase of the interactions corresponding to the artificial spinwave RF pulse via the interaction unit;
measuring the phase of the artificial Ising spinwave RF pulse as the pulse propagates in the ring circuit via a measuring unit connected to the ring circuit; and,
annealing the artificial Ising spinwave RF pulse and performing statistical analysis on the steady-state solutions of the Ising machine via an annealing and computing unit connected to the ring circuit.

36. The method according to claim 35, wherein the measuring unit receives each propagated artificial spinwave RF pulse after the measuring unit completes one set of measurement and before the measuring unit restarts another set of measurement.

37. The method according to claim 35, wherein the method comprises receiving a plurality of microwave RF pulses in the ring circuit.

38. The method according to claim 35, wherein the method comprises delaying the propagation of an artificial Ising spinwave RF pulse in the interaction unit for a duration of exactly one period of pulse repetition time in the ring circuit.
